(19) United States
(12) Patent Application Publication
(10) Pub. No.: US 2025/0227793 A1
(43) Pub. Date: Jul. 10, 2025

(54) TECHNIQUES FOR ENHANCING RADIO LINK FAILURE RECOVERY

(71) Applicant: QUALCOMM Incorporated, San Diego, CA (US)

(72) Inventors: Jing Lei, San Diego, CA (US); Changhwan Park, San Diego, CA (US); Kazuki Takeda, Tokyo (JP)

(21) Appl. No.: 18/405,489

(22) Filed: Jan. 5, 2024

(51) Int. Cl. H04W 76/19; H04L 5/00; H04W 24/10

(52) U.S. Cl. CPC H04W 76/19; H04L 5/001; H04W 24/10

(57) ABSTRACT

Aspects described herein relate to reporting out-of-synchronization on a downlink (DL) to a network entity by transmitting, to the network entity based on comparing a difference between the downlink timing measurement of the signal and a previous downlink timing measurement of a previous signal to a threshold, a report indicating an out-of-synchronization status for DL. In an example, a network entity receiving this report can transmit a response signal to cause the device reporting the out-of-synchronization to correct DL timing or perform a random access procedure.

### FIELD OF THE DISCLOSURE

Aspects of the present disclosure relate generally to wireless communication systems, and more particularly, to recovering from radio link failure (RLF) in wireless communications.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to perform a downlink (DL) timing measurement of a signal received from a network entity, and transmit, to the network entity based on comparing a difference between the downlink timing measurement of the signal and a previous downlink timing measurement of a previous signal to a threshold, a report indicating an out-of-synchronization status for DL.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive, from a user equipment (UE) based on a difference between a DL timing measurement of a signal transmitted to the UE and a previous downlink timing measurement of a previous signal transmitted to the UE being at least equal to or above a threshold, a report indicating an out-of-synchronization status for DL, and transmit, based on the out-of-synchronization status for DL, a response signal to the UE to correct the downlink timing or cause a random access procedure.

In another aspect, a method for wireless communications at a UE is provided that includes performing a DL timing measurement of a signal received from a network entity, and transmitting, to the network entity based on comparing a difference between the downlink timing measurement of the signal and a previous downlink timing measurement of a previous signal to a threshold, a report indicating an out-of-synchronization status for DL.

In another aspect, a method for wireless communications at a network entity is provided that includes receiving, from a UE based on a difference between a DL timing measurement of a signal transmitted to the UE and a previous downlink timing measurement of a previous signal transmitted to the UE being at least equal to or above a threshold, a report indicating an out-of-synchronization status for DL, and transmitting, based on the out-of-synchronization status for DL, a response signal to the UE to correct the downlink timing or cause a random access procedure.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for reporting out-of-synchronization status on a downlink (DL), in accordance with aspects described herein;

FIG. 6 is a flow chart illustrating an example of a method for receiving, from a UE, a report of out-of-synchronization status on a DL, in accordance with aspects described herein; and

FIG. 7 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to recovering from radio link failure (RLF) or beam failure detection (BFD) in wireless communications. For example, a device, such as a user equipment (UE) in fifth generation (5G) new radio (NR) or other wireless communication technologies, can communicate with a network entity or other devices in a wireless communication network. When a device is operating in connected mode with the network entity or other device, it may detect RLF or beam failure in the link between the device and the network entity or other device based on one or more parameters or considerations. When the device detects RLF or beam failure, it may perform a radio resource control (RRC) connection reestablishment procedure to reestablish a link with the network entity or device (or another network entity or device) to maintain a link for wireless communications. For example, in 5G NR, the device may perform the RRC connection reestablishment procedure as part of a random access (RA) procedure performed with the network entity or other device. In 5G NR, one of the possible causes of RLF or beam failure is the downlink (DL) timing of the network entity being out-of-synchronization at the devices receiving signal from the network entity. The DL timing offset can be reflected in autonomous uplink (UL) timing adjustments performed by the device (e.g., UE), which can impact the accuracy of UL timing. If the network entity detects out-of-synchronization on UL, it can issue a physical downlink control channel (PDCCH) order and trigger RA procedure.

In 5G NR, for example, it may be possible for a RA procedure triggered by RLF to overlap with a PDCCH-ordered RA in one or more cases. In one example, a UE can detect that radio link monitoring (RLM) measurements deteriorating due to DL timing drift where the criteria for RLF is not yet met, the UE can accordingly apply a timing advance to UL based on the drifted DL timing, the network entity may then detect out-of-synchronization with the UE. In this example, the RLM measurements may continue deteriorating and meet the RLF criteria, and the UE can accordingly suspend PDCCH monitoring and initiate RRC reestablishment. The network entity can subsequently trigger PDCCH-ordered random access channel (RACH) procedure, which the UE does not receive due to suspending PDCCH monitoring. In another example, before the UE suspends PDCCH monitoring and initiates the RRC reestablishment, the network can trigger the PDCCH-ordered RACH procedure, but the UE may not receive the PDCCH order due to deteriorating radio link. After this, the UE can suspend PDCCH monitoring and initiate RRC reestablishment.

In these cases, due to out-of-synchronization status on the DL, neither the UE nor the network entity is aware that two different RA procedures are going on in parallel. This may be undesirable for both sides due to additional power or energy consumption that may be caused by redundant transmission and/or retransmission of physical RACH (PRACH) by UE, or PDCCH by the network entity, increase of signaling overhead, reduced resource utilization efficiency for RACH resources, ambiguity of UE and/or network entity implementation (e.g., UE receives PDCCH order within a random access response (RAR) window of contention-based RA (CBRA)), etc. Aspects described herein can mitigate the above issues existing in wireless communication technologies such as 5G NR and/or can improve efficiencies (power or energy, resource utilization, signaling, etc.) of device in recovering from RLF and out-of-synchronization conditions.

In one example, a UE can detect out-of-synchronization for the DL and can report (e.g., before RLF) the out-of-synchronization to the network entity. The network entity can receive the out-of-synchronization report and can accordingly attempt to repair the DL timing by scheduling RS signals, provide an early indication for monitoring PDCCH for RA procedure trigger, trigger PDCCH-ordered RA procedure, and/or the like. In these examples, the UE may correct the DL timing based on RSs or may perform a PDCCH-ordered RA procedure before RLF occurs, which can mitigate the cases where the two RA procedures are triggered (one due to occurrence of RLF). This can mitigate or solve the above-mentioned issues otherwise caused by the two RA procedures, and can accordingly decrease power or energy consumption, decrease signaling overhead, improve resource utilization for RACH resources, etc.

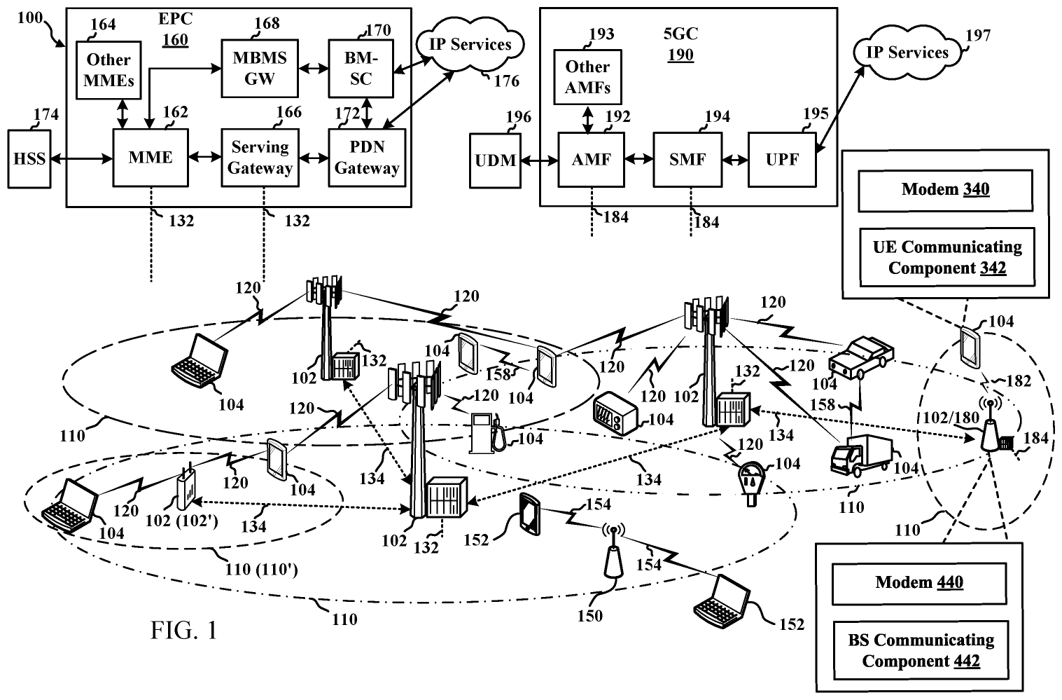

The described features will be presented in more detail below with reference to FIGS. 1-7.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for reporting out-of-synchronization status on a DL, in accordance with aspects described herein. In addition, some nodes may have a modem 440 and BS communicating component 442 for receiving, from a UE, a report of out-of-synchronization status on a DL, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 of a UE 104 can measure DL timing of signals received from a base station 102, and when DL timing has changed by at least a certain amount, UE communicating component 342 can report an out-of-synchronization status for the DL to the base station 102. In an example, BS communicating component 442 of the base station can receive the report from the UE 104 and can accordingly configure the UE 104 to correct the DL timing, provide the UE 104 with early monitoring occasions for a control channel, and/or cause the UE to perform a RA procedure to reestablish connection with the base station 102 or another base station, as described herein.

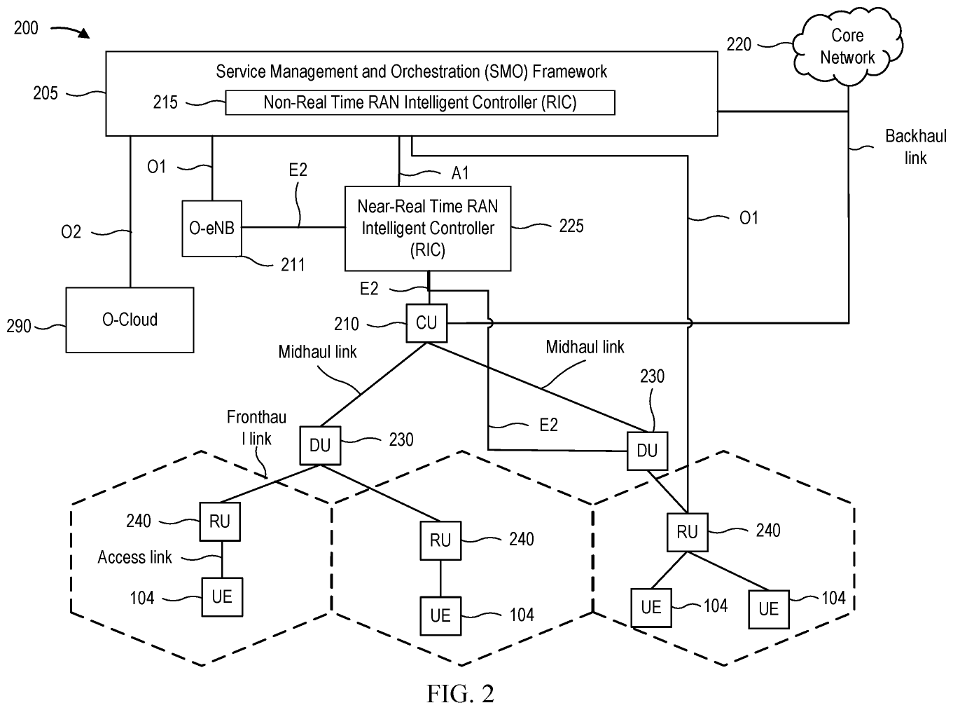

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

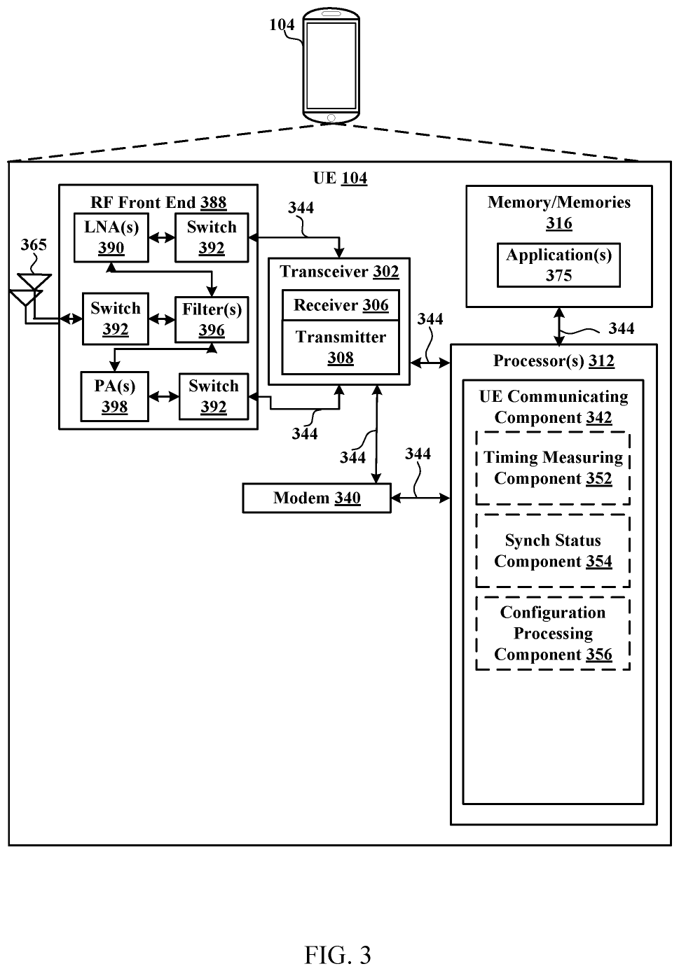

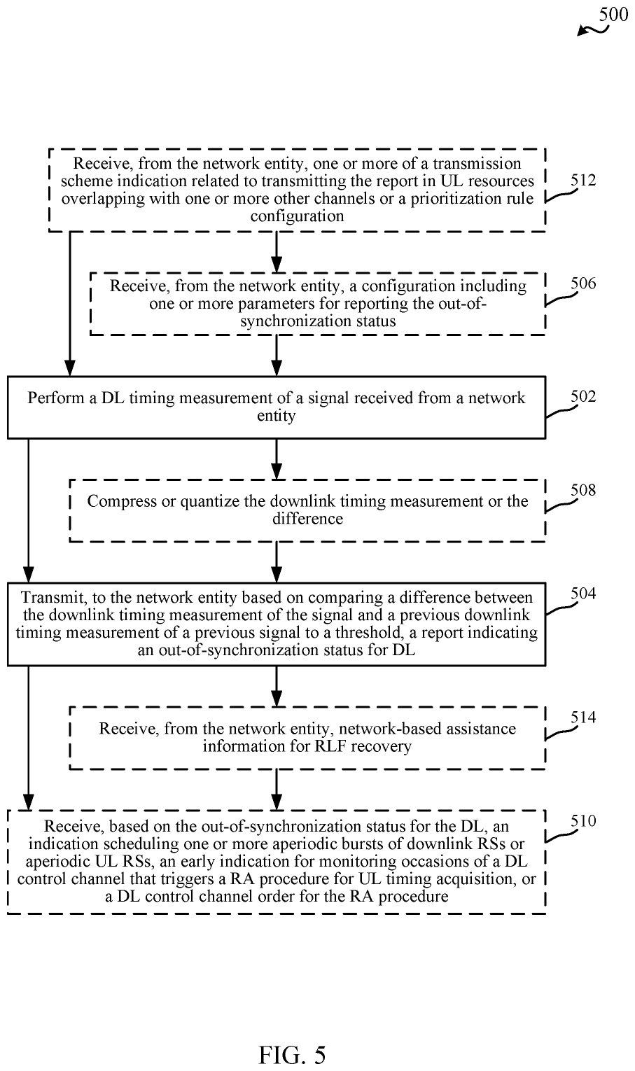

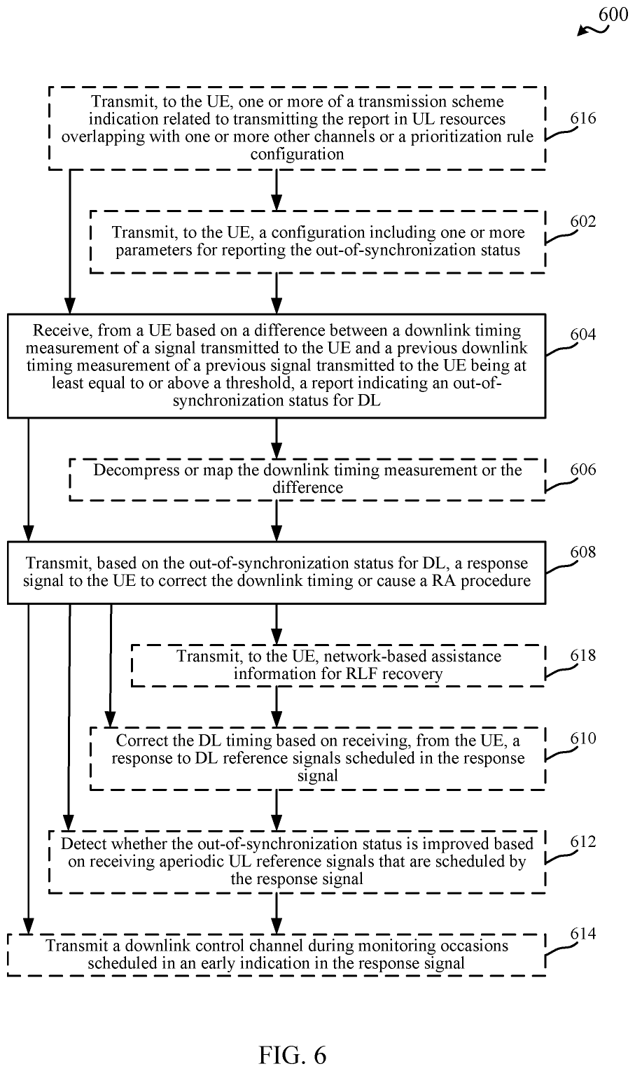

Turning now to FIGS. 3-7, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for reporting out-of-synchronization status on a DL, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a timing measuring component 352 for measuring DL timing of signals received from a base station or other network entity, a synch status component 354 for detecting a synchronization status on the DL based on the DL timing, and/or a configuration processing component 356 for processing a configuration received from the network entity, in accordance with aspects described herein.

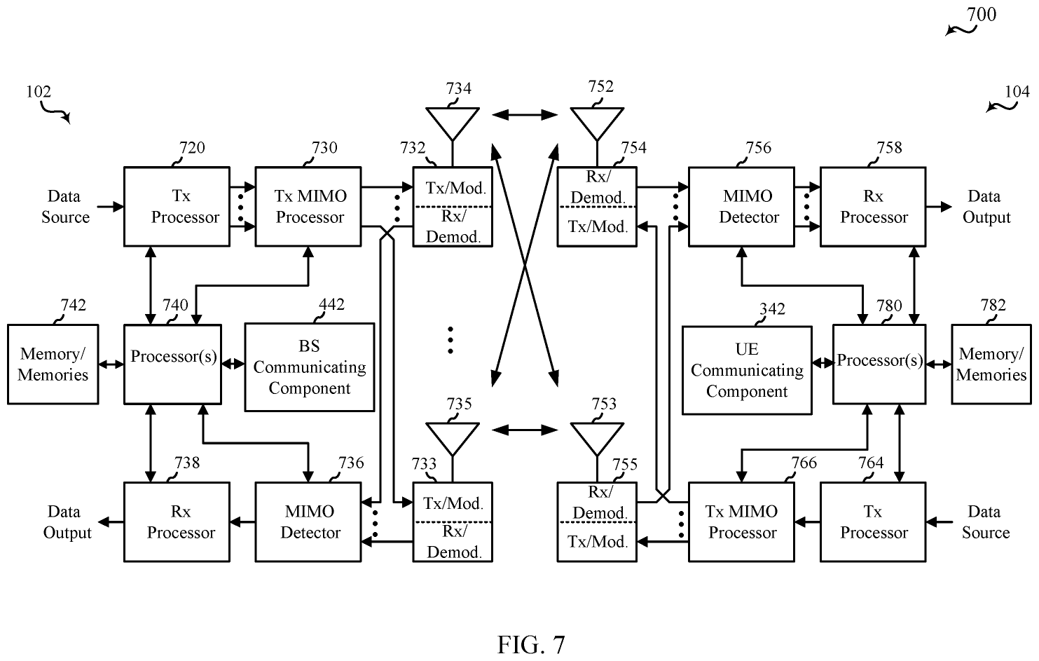

In an aspect, the processor(s) 312 may correspond to one or more of the processors described in connection with the UE in FIG. 7. Similarly, the memory/memories 316 may correspond to the one or more memories described in connection with the UE in FIG. 7.

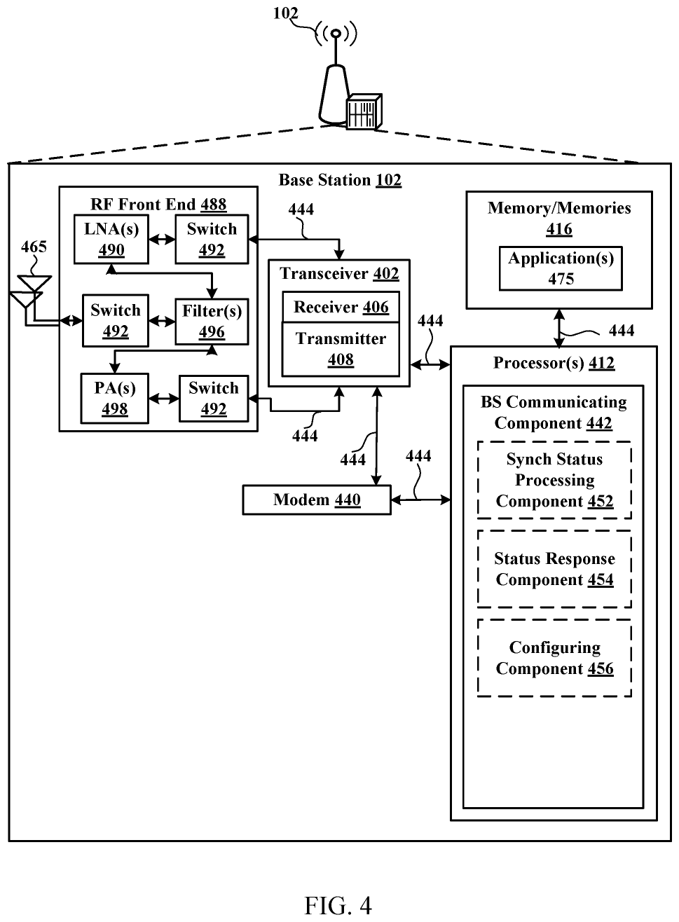

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for receiving, from a UE, a report of out-of-synchronization status on a DL, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a synch status processing component 452 for processing a synchronization status report for a DL as received from a UE, a status response component 454 for responding to the synchronization status report to improve the synchronization at the UE, and/or a configuring component 456 for configuring the UE with one or more parameters, which may be for reporting the synchronization status, improving the synchronization, and/or the like, in accordance with aspects described herein.

In an aspect, the processor(s) 412 may correspond to one or more of the processors described in connection with the base station in FIG. 7. Similarly, the memory/memories 416 may correspond to the one or more memories described in connection with the base station in FIG. 7.

FIG. 5 illustrates a flow chart of an example of a method 500 for reporting out-of-synchronization status on a DL, in accordance with aspects described herein. FIG. 6 illustrates a flow chart of an example of a method 600 for receiving, from a UE, a report of out-of-synchronization status on a DL, in accordance with aspects described herein. In an example, a UE 104 can perform the functions described in method 500 shown in FIG. 5 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 600 shown in FIG. 6 using one or more of the components described in FIGS. 1 and/or 4. Methods 500 and 600 are described in conjunction with one another for ease of explanation; however, the methods 500 and 600 are not required to be performed together and indeed can be performed independently using separate devices.

In an example, a UE 104 can establish a RRC connection with a network entity, such as a base station, and can operate in connected mode by monitoring a control channel (e.g., PDCCH) from the network entity for communications intended for the UE 104. Over time radio conditions between the UE 104 and the network entity can change (e.g., as the UE 104 moves locations, or as other devices or potentially interfering objects move locations), including timing of communications (e.g., a difference between a time communications are transmitted by one node and received by another node). In 5G NR, the UE 104 can autonomously perform UL timing adjustment, which can correspondingly reflect, or be based on, a DL timing offset or difference between timing of transmitting DL signals by the network entity and receiving the signals at the UE 104. In one example, the UE 104 can apply a timing advance for uplink communications based on detecting a drift in DL timing. In an example, the UE 104 can detect the drift in DL timing based on RLM measurements performed by the UE 104 of signals received from the network entity.

In method 500, at Block 502, a DL timing measurement of a signal received from a network entity can be performed. In an aspect, timing measuring component 352, e.g., in conjunction with processor(s) 312, memory/memories 316, transceiver 302, UE communicating component 342, etc., can perform the DL timing measurement of the signal received from the network entity. In one example, timing measuring component 352 can perform the DL timing measurement as part of RLM measurements performed on signals received from the network entity to detect DL timing drift (e.g., for autonomous UL timing adjustment). For example, timing measuring component 352 can know when the signals for RLM are transmitted by the network entity (or are expected to be received by the UE 104 based on a previous timing advance applied), and the timing measuring component 352 can accordingly determine a DL timing measurement of the signal. The DL timing measurement can include the time the signal is received and/or a drift computed from an expected receiving time for the signal. In one example, timing measuring component 352 can perform multiple measurements of the signals over time, and can accordingly detect a drift or difference in drift based on comparing (e.g., subtracting) measurements.

In method 500, at Block 504, a report indicating an out-of-synchronization status for DL can be transmitted to the network entity based on comparing a difference between the downlink timing measurement of the signal and a previous downlink timing measurement of a previous signal to a threshold. In an aspect, synch status component 354, e.g., in conjunction with processor(s) 312, memory/memories 316, transceiver 302, UE communicating component 342, etc., can transmit, to the network entity based on comparing the difference between the downlink timing measurement of the signal and the previous downlink timing measurement of the previous signal to the threshold, the report indicating the out-of-synchronization status for DL. For example, synch status component 354 can compute the difference between the downlink timing measurement and the previous downlink timing measurement to determine an amount of change in the timing between two measurement periods. This may indicate the drift of the downlink timing over time (e.g., between the two measurement periods).

In one example, where the difference achieves a threshold (e.g., is equal to or above the threshold), this may indicate out-of-synchronization on the DL that may soon cause the UE 104 to detect/declare RLF or beam failure. For example, where the UE observes the DL timing has changed by a certain amount, τ, which can be the drift, and the magnitude of τ is above a threshold τ_{TH}, the UE 104 can report the status of out-of-synchronization to the network entity. In one example, synch status component 354 can also report the out-of-synchronization status for DL to the network entity when (or otherwise based on where) a time alignment timer is still running and RLF or BFD has not been declared since the RRC connection was established with the network entity.

In one example, the threshold (e.g., τ_{TH}) can be configured by the network entity in RRC or system information (SI). For example, in method 600, optionally at Block 602, a configuration including one or more parameters for reporting the out-of-synchronization status can be transmitted to a UE. In an aspect, configuring component 456, e.g., in conjunction with processor(s) 412, memory/memories 416, transceiver 402, BS communicating component 442, etc., can transmit, to the UE (e.g., UE 104), the configuration including one or more parameters for reporting the out-of-synchronization status. For example, in method 500, optionally at Block 506, a configuration including one or more parameters for reporting the out-of-synchronization status can be received from the network entity. In an aspect, configuration processing component 356, e.g., in conjunction with processor(s) 312, memory/memories 316, transceiver 302, UE communicating component 342, etc., can receive, from the network entity, and/or process, the configuration including the one or more parameters for reporting the out-of-synchronization status for DL. For example, configuring component 456 can transmit, and/or configuration processing component 356 can receive, the configuration in RRC signaling or SI. In one example, the configuration can indicate the threshold (e.g., τ_{TH}). The configuration can include other parameters, as described herein.

In an example, synch status component 354 can transmit the report in uplink control information (UCI) in resources scheduled by the network entity, in media access control (MAC)-control element (CE), etc. The report can include a measurement for the DL timing offset (e.g., τ or |τ|), or the discrepancy between T and τ_{TH} (e.g., |τ|−τ_{TH} or ∥τ|−τ_{TH}|). In one example, the configuration transmitted by configuring component 456 (e.g., at Block 602), and/or received and processed by configuration processing component 356 (e.g., at Block 506), may indicate the report contents (e.g., whether to include the measurement for DL timing offset or to include the discrepancy). In addition, for example, synch status component 354 may compress or quantize the measurement(s) (e.g., the DL timing offset measurement or the discrepancy) before mapping to UCI or MAC-CE, which may also be based on configuration received from the network entity. For example, in method 500, optionally at Block 508, the downlink timing measurement or the difference can be compressed or quantized. In an aspect, synch status component 354, e.g., in conjunction with processor(s) 312, memory/memories 316, transceiver 302, UE communicating component 342, etc., can compress or quantize the downlink timing measurement or the difference to achieve a value that requires less bits for conveying to the network entity.

In one example, the UE 104 may be configured with multiple component carriers (CCs) over which it communicates with the network entity. The UE 104 may perform the DL timing tracking on one CC that may be different from the CC on which the UE transmits the UCI or MAC-CE or may be different from a DL timing reference of the timing advance group (TAG) to which the UE 104 is assigned. In this example, synch status component 354 may also include, in the report, an indicator of the DL CC on which the DL timing tracking or measurements are performed. The indicator may include an index of the DL CC in a configuration of multiple CCs configured for the UE 104. This may assist the network entity in jointly processing out-of-synchronization reports from multiple CCs, if received.

In yet another example, synch status component 354 can include, in the report, a status (e.g., degradation) of RLM measurements, beam management (BM) measurements, etc., which can assist the network entity in predicting a time window for RLF or beam failure being declared by the UE 104).

In method 600, at Block 604, a report indicating an out-of-synchronization status for DL can be received from a UE based on a difference between a downlink timing measurement of a signal transmitted to the UE and a previous downlink timing measurement of a previous signal transmitted to the UE being at least equal to or above a threshold. In an aspect, synch status processing component 452, e.g., in conjunction with processor(s) 412, memory/memories 416, transceiver 402, BS communicating component 442, etc., can receive, from the UE based on the difference between the downlink timing measurement of the signal transmitted to the UE and the previous downlink timing measurement of the previous signal transmitted to the UE being at least equal to or above a threshold, the report indicating the out-of-synchronization status for DL. For example, as described, the report can be received from the UE 104 in UCI or MAC-CE and/or may include a measurement for the DL timing offset, a discrepancy between the DL timing offset and a threshold, and/or the like.

Moreover, for example, the report can include such values as compressed or quantized values. In this example, in method 600, optionally at Block 606, the downlink timing measurement or the difference can be decompressed or mapped. In an aspect, synch status processing component 452, e.g., in conjunction with processor(s) 412, memory/memories 416, transceiver 402, BS communicating component 442, etc., can decompress or map the downlink timing measurement or the difference from values indicated in the report to actual values, which can be using substantially decompression algorithm or mapping of values known by the UE 104 and network entity. In yet another example, the report can include an index of the CC on which the DL timing tracking is performed, and synch status processing component 452 may process multiple out-of-synchronization reports from multiple CCs based on the indicated indices. In yet another example, the report can include an indication of the status (e.g., degradation) of RLM measurements, BM measurements, etc., which status response component 454 may use to select a certain response to send to the UE 104 for the out-of-synchronization status. For example, if the status of RLM measurements or BM measurements indicates an imminent RLF or beam failure, status response component 454 may select a more severe response, such as to trigger RACH measurements instead of trying to correct the DL timing.

In method 600, at Block 608, a response signal can be transmitted to the UE, based on the out-of-synchronization status for DL, to correct the downlink timing or cause a RA procedure. In an aspect, status response component 454, e.g., in conjunction with processor(s) 412, memory/memories 416, transceiver 402, BS communicating component 442, etc., can transmit, based on the out-of-synchronization status for DL, the response signal to the UE (e.g., UE 104) to correct the DL timing or cause a RA procedure. For example, status response component 454 can transmit the response signal including a response signal that schedules aperiodic bursts of tracking reference signals (e.g., tracking reference signal (TRS), non-cell defining (NCD)-synchronization signal block (SSB), etc.) on the DL. In one example, the UE can receive and use to correct the DL timing (e.g., by applying a timing advance determined from the reference signals). In another example, in method 600, optionally at Block 610, the DL timing can be corrected based on receiving, from the UE, a response to the DL reference signals scheduled in the response signal. In an aspect, synch status processing component 452, e.g., in conjunction with processor(s) 412, memory/memories 416, transceiver 402, BS communicating component 442, etc., can correct the DL timing based on receiving, from the UE, the response to DL reference signals scheduled in the response signal. For example, the response may include DL timing measurements of the DL reference signals performed by the UE 104, and synch status processing component 452 can use the DL timing measurements to generate and send a timing advance command to the UE 104 in this example.

In another example, status response component 454 can transmit the response signal including a response signal that schedules aperiodic RS on the uplink (e.g., sounding reference signal, short preamble or sequence with less overhead than PRACH, etc.), which may be jointly scheduled with DL tracking RS, to help the network entity retune the timing advance MAC-CE without ordering RA. In this example, in method 600, optionally at Block 612, it can be detected whether the out-of-synchronization status is improved based on receiving aperiodic UL reference signals that are scheduled by the response signal. In an aspect, synch status processing component 452, e.g., in conjunction with processor(s) 412, memory/memories 416, transceiver 402, BS communicating component 442, etc., can detect whether the out-of-synchronization status is improved based on receiving the aperiodic UL reference signals that are scheduled by the response signal. For example, synch status processing component 452 can determine that out-of-synchronization status report is no longer being reported by the UE 104 based on adjusting the timing advance MAC-CE.

In another example, status response component 454 can transmit the response signal including a response signal that provides an early indication for monitoring occasions of PDCCH, where the PDCCH candidates on the indicated monitoring occasions can be used to trigger the RA procedure for the UE (e.g., a contention-free RA (CFRA) or contention-based RA (CBRA) procedure). In this example, in method 600, optionally at Block 614, a downlink control channel can be transmitted during the monitoring occasions scheduled in the early indication in the response signal. In an aspect, BS communicating component 442, e.g., in conjunction with processor(s) 412, memory/memories 416, transceiver 402, etc., can transmit the downlink control channel (e.g., PDCCH) during the monitoring occasions scheduled in the early indication in the response signal. For example, BS communicating component 442 can transmit, in the PDCCH, a trigger for an RA procedure based on the out-of-synchronization status reported by the UE 104, which can reduce the probability of parallel RA procedures at the UE 104 and network entity, as described above). In one example, if the UE 104 does not detect the PDCCH-ordered RA procedure by the end of the indicated monitoring occasions, the UE 104 can perform the regular RLF recovery procedure and initiate a RA procedure (e.g., CFRA or CBRA) for RRC connection reestablishment.

In another example, status response component 454 can transmit the response signal including a response signal that triggers a PDCCH-ordered RACH procedure (e.g., immediately or otherwise based on the response signal). This may reduce latency or overhead resulting from the RLF declaration procedure at the UE 104 by ordering the RACH procedure before the UE 104 can detect or declare RLF. In yet another example, status response component 454 can transmit the response signal including any combination of the above examples. Moreover, in some examples, status response component 454 can select the response signal based on information received in the out-of-synchronization report from the UE 104, as described above.

In method 500, optionally at Block 510, one or more of an indication scheduling one or more aperiodic bursts of downlink RSs or aperiodic uplink RSs, an early indication for monitoring occasions of a DL control channel that triggers a RA procedure for UL timing acquisition, or a DL control channel order for the RA procedure can be received based on the out-of-synchronization status for the DL. In an aspect, UE communicating component 342, e.g., in conjunction with processor(s) 312, memory/memories 316, transceiver 302, etc., can receive, based on the out-of-synchronization status for the DL, one or more of the indication scheduling one or more aperiodic bursts of downlink RSs or aperiodic uplink RSs, the early indication for monitoring occasions of a DL control channel that triggers a RA procedure for UL timing acquisition, or the DL control channel order for the RA procedure, as described above. For example, UE communicating component 342 can receive the aperiodic bursts of DL RSs and can measure and/or report timing for the DL RSs. In another example, UE communicating component 342 can transmit aperiodic UL RSs as scheduled by the network entity. In yet another example, UE communicating component 342 can receive the early indication of monitoring occasions of the DL control channel and can monitor for a signal that triggers RA and/or can receive the signal triggering RA and accordingly initiate a RA procedure with the network entity or another network entity in range of the UE 104. In one example, if the UE 104 does not receive any response signal from the network entity and the RLM measurements performed by the UE 104 continue deteriorating, the UE 104 can perform regular RLF when the criteria are met to declare RLF and/or accordingly perform a UE-initiated RA procedure.

In one example, a priority for the UE's reporting out-of-synchronization can be configured and/or indicated by the network entity. For example, when the reporting overlaps with other UL transmissions, or collides with DL transmissions, the UE 104 can arbitrate based on the priority indication for the out-of-synchronization status report. In another example, based on the priority indication, the UE 104 can apply power boosting or dynamic power sharing to transmit the out-of-synchronization status report, or select the multiplexing scheme with other UL channels (e.g., UCI piggyback on physical uplink shared channel (PUSCH)).

Thus, for example, in method 600, optionally at Block 616, one or more of a transmission scheme indication related to transmitting the report in UL resources overlapping with one or more other channels, or a prioritization rule configuration, can be transmitted to the UE. In an aspect, configuring component 456, e.g., in conjunction with processor(s) 412, memory/memories 416, transceiver 402, BS communicating component 442, etc., can transmit, to the UE, the transmission scheme indication related to transmitting the report in UL resources overlapping with one or more other channels or a prioritization rule configuration. For example, the one or more other channels may be UL channels or DL channels scheduled by the network entity. In an example, the transmission scheme indication can include a priority indication indicating to prioritize (or whether to prioritize) the out-of-synchronization status report over the one or more other channels (e.g., over receiving DL communications in overlapping DL resources or over transmitting UL communications in overlapping UL resources). In another example, the prioritization rule configuration can include the indicator of whether to prioritize transmitting out-of-synchronization status reports over other channels. In an example, configuring component 456 can transmit the transmission scheme indication in dynamic signaling, such as DCI or MAC-CE, and/or can transmit the prioritization rule configuration in semi-static signaling, such as RRC or SI, etc.

In method 500, optionally at Block 512, one or more of a transmission scheme indication related to transmitting the report in UL resources overlapping with one or more other channels, or a prioritization rule configuration, can be received from the network entity. In an aspect, configuration processing component 356, e.g., in conjunction with processor(s) 312, memory/memories 316, transceiver 302, UE communicating component 342, etc., can receive, from the network entity, the transmission scheme indication related to transmitting the report in UL resources overlapping with one or more other channels or the prioritization rule configuration, as described above. Synch status component 354 can report the out-of-synchronization status in accordance with the configured prioritization rules.

In one example, where the resources for the out-of-synchronization status report overlap with resources of one or more other UL channels, synch status component 354 can transmit the report (e.g., at Block 504) by multiplexing the report with one or more other UL channels based on the transmission scheme indication, the prioritization rule configuration, a UE capability, or a UE processing timeline requirement, or a combination thereof. In one example, the UE 104 can report the UE capability to the network entity. Similarly, for example, in receiving the out-of-synchronization status report (e.g., at Block 604), synch status processing component 452 can demultiplex the report from one or more other UL channels based on the transmission scheme indication, the prioritization rule configuration, the UE capability, or the UE processing timeline requirement, or a combination thereof.

In another example, the network entity can provide assistance information to the UE 104, in DCI or MAC-CE, etc., for the purposes of performing for RLF or BFD recovery, and the UE 104 can use the assistance information in performing RLF or BFD recovery (e.g., after declaring RLF or BFD). Thus, for example, in method 600, optionally at Block 618, network-based assistance information can be transmitted to the UE for RLF or BFD recovery. In an aspect, configuring component 456, e.g., in conjunction with processor(s) 412, memory/memories 416, transceiver 402, BS communicating component 442, etc., can transmit, to the UE, the network-based assistance information for RLF or BFD recovery. For example, configuring component 456 can transmit the network-based assistance information in dynamic or semi-static signaling to the UE 104, as described. In method 500, optionally at Block 514, network-based assistance information for RLF or BFD recovery, can be received from the network entity. In an aspect, configuration processing component 356, e.g., in conjunction with processor(s) 312, memory/memories 316, transceiver 302, UE communicating component 342, etc., can receive, from the network entity, the network-based assistance information for RLF or BFD recovery. In an example, UE communicating component 342 can use the assistance information in performing RLF or BFD recovery (e.g., after detecting or declaring RLF based on deteriorating RLM measurements). For example, the assistance information can include a configuration or indication for a physical PRACH resource that can be shared by RLF or BFD recovery and a PDCCH-ordered RACH procedure at the UE 104. This can improve utilization efficiency of PRACH. In another example, the assistance information can indicate whether UE 104 needs to monitor PDCCH order within the RAR window for CBRA, if the UE 104 declares RLF or BFD without sending out-of-synchronization status report, or the UE 104 does not receive a response from the network entity after sending out-of-synchronization status report. This may reduce the ambiguity of UE implementation in RLF or BFD.

FIG. 7 is a block diagram of a MIMO communication system 700 including a base station 102 and a UE 104. The MIMO communication system 700 may illustrate aspects of the wireless communication access network 100 described with reference to FIG. 1. The base station 102 may be an example of aspects of the base station 102 described with reference to FIG. 1. The base station 102 may be equipped with antennas 734 and 735, and the UE 104 may be equipped with antennas 752 and 753. In the MIMO communication system 700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 720 may receive data from a data source. The transmit processor 720 may process the data. The transmit processor 720 may also generate control symbols or reference symbols. A transmit MIMO processor 730 may perform spatial processing (e.g., precoding) on data symbols, control symbols, or reference symbols, if applicable, and may provide output symbol streams to the transmit modulator/demodulators 732 and 733. Each modulator/demodulator 732 through 733 may process a respective output symbol stream (e.g., for OFDM, etc.) to obtain an output sample stream. Each modulator/demodulator 732 through 733 may further process (e.g., convert to analog, amplify, filter, and upconvert) the output sample stream to obtain a DL signal. In one example, DL signals from modulator/demodulators 732 and 733 may be transmitted via the antennas 734 and 735, respectively.

The UE 104 may be an example of aspects of the UEs 104 described with reference to FIGS. 1 and 3. At the UE 104, the UE antennas 752 and 753 may receive the DL signals from the base station 102 and may provide the received signals to the modulator/demodulators 754 and 755, respectively. Each modulator/demodulator 754 through 755 may condition (e.g., filter, amplify, downconvert, and digitize) a respective received signal to obtain input samples. Each modulator/demodulator 754 through 755 may further process the input samples (e.g., for OFDM, etc.) to obtain received symbols. A MIMO detector 756 may obtain received symbols from the modulator/demodulators 754 and 755, perform MIMO detection on the received symbols, if applicable, and provide detected symbols. A receive (Rx) processor 758 may process (e.g., demodulate, deinterleave, and decode) the detected symbols, providing decoded data for the UE 104 to a data output, and provide decoded control information to a processor(s) 780, or memory/memories 782.

The processor(s) 780 may in some cases execute stored instructions to instantiate a UE communicating component 342 (see e.g., FIGS. 1 and 3).

On the uplink (UL), at the UE 104, a transmit processor 764 may receive and process data from a data source. The transmit processor 764 may also generate reference symbols for a reference signal. The symbols from the transmit processor 764 may be precoded by a transmit MIMO processor 766 if applicable, further processed by the modulator/demodulators 754 and 755 (e.g., for single carrier-FDMA, etc.), and be transmitted to the base station 102 in accordance with the communication parameters received from the base station 102. At the base station 102, the UL signals from the UE 104 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor(s) 740 or memory/memories 742.

The processor(s) 740 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 700.

The following aspects are illustrative only and aspects thereof may be combined with aspects of other embodiments or teaching described herein, without limitation.

Aspect 1 is a method for wireless communications at a UE including performing a DL timing measurement of a signal received from a network entity, and transmitting, to the network entity based on comparing a difference between the downlink timing measurement of the signal and a previous downlink timing measurement of a previous signal to a threshold, a report indicating an out-of-synchronization status for DL.

In Aspect 2, the method of Aspect 1 includes where transmitting the out-of-synchronization status for DL is further based on a time alignment timer not being expired and RLF or BFD not being declared.

In Aspect 3, the method of any of Aspects 1 or 2 includes receiving, from the network entity, a configuration including an indication of the threshold in RRC signaling or SI.

In Aspect 4, the method of any of Aspects 1 to 3 includes where transmitting the out-of-synchronization status for DL includes transmitting UCI or MAC-CE indicating the out-of-synchronization status for DL.

In Aspect 5, the method of any of Aspects 1 to 4 includes where the report includes an indication of the downlink timing measurement or a difference between the downlink timing measurement and the threshold.

In Aspect 6, the method of Aspect 5 includes compressing or quantizing the downlink timing measurement or the difference, where the report includes the compressed or quantized downlink timing measurement or difference.

In Aspect 7, the method of any of Aspects 1 to 6 includes where the report includes an indication of a CC index over which the signal is received on DL.

In Aspect 8, the method of any of Aspects 1 to 7 includes where the report additionally includes a RLM measurement or an indication of a status of RLM measurements performed by the UE, or a BM measurement or an indication of a status of BM measurements.

In Aspect 9, the method of any of Aspects 1 to 8 includes receiving, from the network entity, one or more of a transmission scheme indication related to transmitting the report in UL resources overlapping with one or more other UL channels or one or more other DL channels, or a prioritization rule configuration semi-statically configured by the network entity.

In Aspect 10, the method of Aspect 9 includes transmitting the report includes transmitting the report instead of transmitting the one or more other UL channels or receiving the one or more other DL channels based on a priority indication included in the transmission scheme indication, or the prioritization rule configuration.

In Aspect 11, the method of any of Aspects 9 or 10 includes where transmitting the report includes applying power boosting or dynamic power sharing based on the transmission scheme indication or the prioritization rule configuration.

In Aspect 12, the method of any of Aspects 9 to 11 includes where transmitting the report includes multiplexing the report with the one or more other UL channels based on the transmission scheme indication, the prioritization rule configuration, a UE capability, a UE processing timeline requirement, or a combination thereof.

In Aspect 13, the method of any of Aspects 1 to 12 includes receiving, based on the out-of-synchronization status for DL, an indication scheduling one or more of aperiodic bursts of downlink reference signals or aperiodic uplink reference signals.

In Aspect 14, the method of any of Aspects 1 to 13 includes receiving, based on the out-of-synchronization status for DL, an early indication for monitoring occasions of a downlink control channel that triggers a random access procedure for UL timing acquisition.

In Aspect 15, the method of any of Aspects 1 to 14 includes receiving, based at least in part on transmitting the out-of-synchronization status for DL, a downlink control channel order for a random access procedure.

In Aspect 16, the method of any of Aspects 1 to 15 includes receiving, based at least in part on the out-of-synchronization status for DL, network-based assistance information for radio link failure recovery.

In Aspect 17, the method of Aspect 16 includes where the network-based assistance information includes an indication that a PRACH resource can be shared by a radio link failure recovery or a beam failure recovery process and a random access procedure ordered by a downlink control channel.

In Aspect 18, the method of any of Aspects 16 or 17 where the network-based assistance information indicates whether the UE is to monitor for a downlink control channel associated with a random access procedure ordered by the network entity within a random access response window associated with a UE-initiated random access procedure.

Aspect 19 is a method for wireless communications at a network entity includes receiving, from a UE based on a difference between a DL timing measurement of a signal transmitted to the UE and a previous downlink timing measurement of a previous signal transmitted to the UE being at least equal to or above a threshold, a report indicating an out-of-synchronization status for DL, and transmitting, based on the out-of-synchronization status for DL, a response signal to the UE to correct the downlink timing or cause a random access procedure.

In Aspect 20, the method of Aspect 19 includes transmitting, to the UE, a configuration including an indication of the threshold in RRC signaling or SI.

In Aspect 21, the method of any of Aspects 19 or 20 includes where receiving the out-of-synchronization status for DL includes receiving UCI or MAC-CE indicating the out-of-synchronization status for DL.

In Aspect 22, the method of any of Aspects 19 to 21 includes where the report includes an indication of the downlink timing measurement or a difference between the downlink timing measurement and the threshold.

In Aspect 23, the method of Aspect 22 includes decompressing or mapping the downlink timing or the difference from a value specified in the report.

In Aspect 24, the method of any of Aspects 19 to 23 includes where the report includes an indication of a CC index over which the signal is received on DL.

In Aspect 25, the method of any of Aspects 19 to 24 includes where the report additionally includes a RLM measurement or an indication of a status of RLM measurements performed by the UE, or BM measurement or an indication of a status of the BM measurements, and where transmitting the response signal is based on the RLM measurement, the status of the RLM measurements, the BM measurement, or the status of the BM measurements.

In Aspect 26, the method of any of Aspects 19 to 25 includes transmitting, to the UE, one or more of a transmission scheme indication related to transmitting the report in UL resources overlapping with one or more other UL channels or one or more other DL channels, or a prioritization rule configuration semi-statically configured by the network entity.

In Aspect 27, the method of Aspect 26 includes where receiving the report includes demultiplexing the report from the one or more other UL channels based on the transmission scheme indication, the prioritization rule configuration, a UE capability, a UE processing timeline requirement, or a combination thereof.

In Aspect 28, the method of any of Aspects 19 to 27 includes where the response signal includes an indication scheduling aperiodic bursts of downlink reference signals, and correcting the downlink timing based on receiving, from the UE, a response to the downlink reference signals.

In Aspect 29, the method of any of Aspects 19 to 28 includes where the response signal includes an indication scheduling aperiodic uplink reference signals, and detecting whether the out-of-synchronization status is improved based on the aperiodic uplink reference signals.

In Aspect 30, the method of any of Aspects 19 to 29 includes where the response signal includes an early indication for monitoring occasions of a downlink control channel that triggers a random access procedure for UL timing acquisition, and transmitting the downlink control channel during the monitoring occasions.

In Aspect 31, the method of any of Aspects 19 to 30 includes where the response signal includes a downlink control channel order for a random access channel procedure.

In Aspect 32, the method of any of Aspects 19 to 31 includes transmitting, based on at least in part on the out-of-synchronization status for DL, network-based assistance information for radio link failure recovery.

In Aspect 33, the method of Aspect 32 includes where the network-based assistance information includes an indication that a PRACH resource can be shared by a radio link failure recovery or a beam failure recovery process and a random access procedure ordered by a downlink control channel.

In Aspect 34, the method of any of Aspects 32 or 33 includes where the network-based assistance information indicates whether the UE is to monitor for a downlink control channel associated with a random access procedure ordered by the network entity within a random access response window associated with a UE-initiated random access procedure.

Aspect 35 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 34.

Aspect 36 is an apparatus for wireless communication including means for performing any of the methods of Aspects 1 to 34.

Aspect 37 is one or more computer-readable media including code executable by one or more processors for wireless communications, the code including code for performing any of the methods of Aspects 1 to 34.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
perform a downlink (DL) timing measurement of a signal received from a network entity; and
transmit, to the network entity based on comparing a difference between the downlink timing measurement of the signal and a previous downlink timing measurement of a previous signal to a threshold, a report indicating an out-of-synchronization status for DL.

2. The apparatus of claim 1, wherein the one or more processors are, individually or in combination, configured to execute the instructions to cause the apparatus to transmit the out-of-synchronization status for DL further based on a time alignment timer not being expired and radio link failure (RLF) or beam failure detection (BFD) not being declared.

3. The apparatus of claim 1, wherein the one or more processors are, individually or in combination, configured to execute the instructions to cause the apparatus to receive, from the network entity, a configuration including an indication of the threshold in radio resource control (RRC) signaling or system information (SI).

4. The apparatus of claim 1, wherein the one or more processors are, individually or in combination, configured to execute the instructions to cause the apparatus to transmit the out-of-synchronization status for DL in uplink control information (UCI) or media access control (MAC)-control element (CE).

5. The apparatus of claim 1, wherein the report includes an indication of the downlink timing measurement or a difference between the downlink timing measurement and the threshold.

6. The apparatus of claim 5, wherein the one or more processors are, individually or in combination, configured to execute the instructions to cause the apparatus to compress or quantize the downlink timing measurement or the difference, wherein the report includes the compressed or quantized downlink timing measurement or difference.

7. The apparatus of claim 1, wherein the report includes an indication of a component carrier (CC) index over which the signal is received on DL.

8. The apparatus of claim 1, wherein the report additionally includes a radio link monitoring (RLM) measurement or an indication of a status of RLM measurements performed by the apparatus, or a beam management (BM) measurement or an indication of a status of BM measurements.

9. The apparatus of claim 1, wherein the one or more processors are, individually or in combination, configured to execute the instructions to cause the apparatus to receive, from the network entity, one or more of:
a transmission scheme indication related to transmitting the report in uplink (UL) resources overlapping with one or more other UL channels or one or more other DL channels; or
a prioritization rule configuration semi-statically configured by the network entity.

10. The apparatus of claim 9, wherein the one or more processors are, individually or in combination, configured to execute the instructions to cause the apparatus to transmit the report instead of transmitting the one or more other UL channels or receiving the one or more other DL channels based on a priority indication included in the transmission scheme indication, or the prioritization rule configuration.

11. The apparatus of claim 9, wherein the one or more processors are, individually or in combination, configured to execute the instructions to cause the apparatus to transmit the report at least in part by applying power boosting or dynamic power sharing based on the transmission scheme indication or the prioritization rule configuration.

12. The apparatus of claim 9, wherein the one or more processors are, individually or in combination, configured to execute the instructions to cause the apparatus to transmit the report at least in part by multiplexing the report with the one or more other UL channels based on the transmission scheme indication, the prioritization rule configuration, a user equipment (UE) capability, a UE processing timeline requirement, or a combination thereof.

13. The apparatus of claim 1, wherein the one or more processors are, individually or in combination, configured to execute the instructions to cause the apparatus to receive, based on the out-of-synchronization status for DL, an indication scheduling one or more of aperiodic bursts of downlink reference signals or aperiodic uplink reference signals.

14. The apparatus of claim 1, wherein the one or more processors are, individually or in combination, configured to execute the instructions to cause the apparatus to receive, based on the out-of-synchronization status for DL, an early indication for monitoring occasions of a downlink control channel that triggers a random access procedure for UL timing acquisition.

15. The apparatus of claim 1, wherein the one or more processors are, individually or in combination, configured to execute the instructions to cause the apparatus to receive, based at least in part on transmitting the out-of-synchronization status for DL, a downlink control channel order for a random access procedure.

16. The apparatus of claim 1, wherein the one or more processors are, individually or in combination, configured to execute the instructions to cause the apparatus to receive, based at least in part on the out-of-synchronization status for DL, network-based assistance information for radio link failure recovery.

17. The apparatus of claim 16, wherein the network-based assistance information includes an indication that a physical random access channel (PRACH) resource can be shared by a radio link failure recovery or a beam failure recovery process and a random access procedure ordered by a downlink control channel.

18. The apparatus of claim 16, wherein the network-based assistance information indicates whether the apparatus is to monitor for a downlink control channel associated with a random access procedure ordered by the network entity within a random access response window associated with a user equipment (UE)-initiated random access procedure.

19. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a user equipment (UE) based on a difference between a downlink (DL) timing measurement of a signal transmitted to the UE and a previous downlink timing measurement of a previous signal transmitted to the UE being at least equal to or above a threshold, a report indicating an out-of-synchronization status for DL; and
transmit, based on the out-of-synchronization status for DL, a response signal to the UE to correct the downlink timing or cause a random access procedure.

20. The apparatus of claim 19, wherein the one or more processors are, individually or in combination, configured to execute the instructions to cause the apparatus to transmit, to the UE, a configuration including an indication of the threshold in radio resource control (RRC) signaling or system information (SI).

21. The apparatus of claim 19, wherein the one or more processors are, individually or in combination, configured to execute the instructions to cause the apparatus to receive the out-of-synchronization status for DL in uplink control information (UCI) or media access control (MAC)-control element (CE).

22. The apparatus of claim 19, wherein the report includes an indication of the downlink timing measurement or a difference between the downlink timing measurement and the threshold.

23. The apparatus of claim 22, wherein the one or more processors are, individually or in combination, configured to execute the instructions to cause the apparatus to decompress or map the downlink timing or the difference from a value specified in the report.

24. The apparatus of claim 19, wherein the report includes an indication of a component carrier (CC) index over which the signal is received on DL.

25. The apparatus of claim 19, wherein the report additionally includes a radio link monitoring (RLM) measurement or an indication of a status of RLM measurements performed by the UE, or beam management (BM) measurement or an indication of a status of the BM measurements, and wherein transmitting the response signal is based on the RLM measurement, the status of the RLM measurements, the BM measurement, or the status of the BM measurements.

26. The apparatus of claim 19, wherein the one or more processors are, individually or in combination, configured to execute the instructions to cause the apparatus to transmit, to the UE, one or more of:
a transmission scheme indication related to transmitting the report in uplink (UL) resources overlapping with one or more other UL channels or one or more other DL channels; or
a prioritization rule configuration semi-statically configured by the apparatus.

27. A method for wireless communications at a user equipment (UE), comprising:
performing a downlink (DL) timing measurement of a signal received from a network entity; and
transmitting, to the network entity based on comparing a difference between the downlink timing measurement of the signal and a previous downlink timing measurement of a previous signal to a threshold, a report indicating an out-of-synchronization status for DL.

28. The method of claim 27, wherein transmitting the out-of-synchronization status for DL is further based on a time alignment timer not being expired and radio link failure (RLF) or beam failure detection (BFD) not being declared.

29. A method for wireless communications at a network entity, comprising:
receiving, from a user equipment (UE) based on a difference between a downlink (DL) timing measurement of a signal transmitted to the UE and a previous downlink timing measurement of a previous signal transmitted to the UE being at least equal to or above a threshold, a report indicating an out-of-synchronization status for DL; and
transmitting, based on the out-of-synchronization status for DL, a response signal to the UE to correct the downlink timing or cause a random access procedure.

30. The method of claim 29, further comprising transmitting, to the UE, a configuration including an indication of the threshold in radio resource control (RRC) signaling or system information (SI).
